(19) United States
(12) Patent Application Publication
(10) Pub. No.: US 2024/0310044 A1
(43) Pub. Date: Sep. 19, 2024

(54) ELECTRICAL HEATER RADIANT BOX PURGE AND PRESSURE RELIEF

(71) Applicant: LUMMUS TECHNOLOGY LLC, Houston, TX (US)

(72) Inventors: Baozhong Zhao, Houston, TX (US); Xueping Li, Houston, TX (US); Eduardo Hart, Houston, TX (US); Benedict Cardaci, Houston, TX (US); Sehjin Kim, Houston, TX (US); William Morgan, Houston, TX (US)

(73) Assignee: LUMMUS TECHNOLOGY LLC, Houston, TX (US)

(21) Appl. No.: 18/604,100

(22) Filed: Mar. 13, 2024

Related U.S. Application Data
(60) Provisional application No. 63/451,900, filed on Mar. 13, 2023.

(51) Int. Cl. F23N 3/02; H05B 1/00

(52) U.S. Cl. CPC F23N 3/02; H05B 1/00

(57) ABSTRACT

Electrical heater systems including one or multiple electrical heaters and a stack for combusting materials leaked into and vented from the electrical heaters. Configurations may include fluid conduits, pressure doors and other equipment for controlling a flow of leaked process fluid between the heater enclosure and the stack. Configurations may also include a purge gas distribution system for purging heater enclosures and preventing thermal shock of electrical heating elements.

### FIELD OF THE DISCLOSURE

Embodiments of the present disclosure generally relate to electrical heaters and their use in processing and heating hydrocarbons and other substances. Embodiments herein further provide for effectively addressing process coil leakage or rupture within the electrical heaters.

### BACKGROUND

Electrical heaters have become a major option for CO2 reduction in petrochemical and other industries where fossil fuels, mainly carbon containing fuels, are fired as a source of energy. In a conventional fired heater, carbon containing fossil fuels are fired in the fired heater to provide energy either to increase the process stream temperature or to support endothermic chemical reactions. The carbon containing fuel firing will lead to CO2 emissions. To minimize CO2 emissions, options of low carbon containing fuel firing, such as high hydrogen fuel or pure hydrogen fuel or ammonia, are under intensive evaluation. Further, when low carbon containing fuels are not readily available, the use of electrical heating becomes a major option. The electrical power supply can be either from green energy or a source from which the CO2 can be captured through more economical technologies.

For electrical heaters, the energy is from electric power and there will be no combustion exhaust gases. The electric heating elements radiate energy to the radiant heating surface and to the refractory. The radiant heating surface receives energy from both the heating elements and the refractory. Since there is no fuel combustion involved, there will be no flue gas and thus a convection section will not be installed. There are also electrical heaters in which both the heating elements and heat receiving surfaces are immersed in a heat transfer fluid, whereby the electric energy from the heating elements heats up the surrounding heat transfer fluid by heat conduction and/or convective heat transfer, then, the heat transfer fluid transfers the energy to the heat receiving surface.

To increase the heat transfer efficiency and minimize the heat loss and capital cost, electrical heaters will have relatively more compact radiant box and minimum ambient air movement through the radiant box. Accordingly, air leakage into or out of the radiant box will be controlled.

However, the electrical heater may be handling a combustible hydrocarbon stream or a high temperature high pressure stream. When the process coil carrying the fluid to be heated has a mechanical failure, such as tube cracks or ruptures, the process stream may leak into the radiant box or electrical heater box. This can result in radiant or electrical heater box pressure increases that may cause an electrical heater structure failure or the high temperature/pressure stream may escape the radiant box through structure steel connection joints or a coil or heating element penetration area that could lead to open flames or a hazardous work environment around the electrical heater area.

Prior practice for dealing with such leaks may include use of explosion doors or connecting the electrical heaters to a fired heater. The explosion doors, when functioning properly, will protect the heater from over pressure. The prior art that connects the electrical heater with a fired heater may cause unexpected sudden combustion or explosion in the connecting duct before the combustible gases for the electrical heater reaches to the fired heater. On the other hand, the combustible gases from the electrical heater may cause overheating to the fired heater.

### SUMMARY OF THE CLAIMED EMBODIMENTS

Embodiments herein are directed toward electrical heaters configured to purge or remove any potential combustible or hazardous gas accumulation inside the radiant box. Embodiments herein provide a design that will allow radiant or electrical heater box purge and pressure relief that guides any combustible or hazardous gases, if leaked into the radiant or electrical heater box, to a safe location. Embodiments herein further provide a pressure-neutral environment under normal operating conditions to minimize any air leakage into or out of the radiant or electrical heater box.

In one aspect, embodiments disclosed herein relate to an electrical heater system. The electrical heating system includes an electrical heater comprising an enclosure containing a refractory, electrical heating elements, and a process coil. The electrical heater system also includes a stack having an air draft inlet proximate a lower portion of the stack and a flue gas outlet at a top of the stack. A fluid conduit fluidly connects the enclosure to the stack intermediate the air draft inlet and the flue gas outlet. A pressure relief mechanism is also provided, configured for exhausting fluid from the enclosure into the fluid conduit. The system also includes a flame holder configured for permitting fluid flow from the fluid conduit into the stack while restricting flow of air or flame into the fluid conduit. A pilot is disposed within the stack proximate the flame holder to ignite combustibles passing from the fluid conduit into the stack.

In another aspect, embodiments disclosed herein relate to an electrical heater system. The electrical heater system includes an electrical heater comprising an enclosure containing a refractory, electrical heating elements, and a process coil. The electrical heater system also includes a stack having an air draft inlet proximate a lower portion of the stack and a flue gas outlet at a top of the stack. A fluid conduit fluidly connects the enclosure to the stack. Further, a pressure relief mechanism is provided for exhausting fluid from the enclosure into the fluid conduit and a purge gas distribution system is disposed in a floor of the enclosure or in a wall along the floor of the enclosure.

In another aspect, embodiments disclosed herein relate to an electrical heater system. The electrical heater system includes two or more electrical heaters, each comprising an enclosure containing refractory, electrical heating elements, and a process coil. The electrical heater system also includes a stack having an air draft inlet proximate a lower portion of the stack and a flue gas outlet at a top of the stack. A fluid collection system fluidly connects each of the enclosures to the stack, including inlet fluid conduits, a header, and a header outlet. The fluid collection system comprises: a pressure relief mechanism disposed proximate a fluid outlet of each enclosure, each pressure relief mechanism configured for exhausting fluid from a respective enclosure into a respective inlet fluid conduit; and a header fluidly connecting two or more inlet fluid conduits, configured for receiving fluids from each of the two or more inlet fluid conduits and directing a flow of received fluids to the header outlet. A flame holder is provided for permitting fluid to flow from the header outlet into the stack while restricting flow of air or flame into the fluid conduit, and a pilot disposed within the stack proximate the flame holder.

In yet another aspect, embodiments herein are directed toward a method of operating an electrical heating system including an enclosure containing refractory, electrical heating elements, and a plurality process coils. The method includes supplying electrical energy to the electrical heating elements to provide radiant energy to the plurality of process coils, and passing a process fluid through the plurality of process coils and heating the process fluid via the radiant energy. During operations, the method may include detecting a leak or rupture of a first of the plurality of process coil introducing a leaked process fluid into the enclosure. The method then includes directing the leaked process fluid through an outlet of the enclosure into a fluid conduit and from the fluid conduit to a refractory inlet of a stack, the refractory inlet being disposed intermediate a draft inlet and a flue gas outlet of the stack and igniting the leaked process fluid within the stack via a pilot disposed proximate the refractory inlet.

In a still further aspect, embodiments herein are directed toward a method of shutting down an electrical heating system including an enclosure containing a refractory disposed on walls, ceiling, and floor of the enclosure, electrical heating elements, and one or more process coils. The method includes supplying electrical energy to the electrical heating elements to provide radiant energy to the one or more process coils and the refractory, including the refractory floor; and terminating the electrical energy being supplied to the electrical heating elements. The method further includes heating a purge gas within a distribution system disposed in the refractory floor; and introducing heated purge gas into the enclosure.

Other aspects and advantages will be apparent from the following description and the appended claims.

### BRIEF DESCRIPTION OF DRAWINGS

FIG. 1 illustrates a prior art fired heater.

FIG. 2 illustrates a prior art electrical heater.

FIG. 3 illustrates an electrical heater system according to one or more embodiments herein.

FIG. 4 illustrates an arrangement of a multiple electrical heater system according to one or more embodiments herein.

FIG. 5 illustrates a pressure relief system that is useful with electrical heater and multiple electrical heater systems according to one or more embodiments herein.

FIGS. 6 and 7 illustrates a design configuration for a stack of electrical heater systems according to one or more embodiments herein.

FIGS. 8 and 9 illustrate purge systems useful with embodiments of electrical heater systems according to one or more embodiments herein.

### DETAILED DESCRIPTION

Embodiments herein relate generally to systems and processes for purge and pressure relief of an electrically heated radiant box heaters.

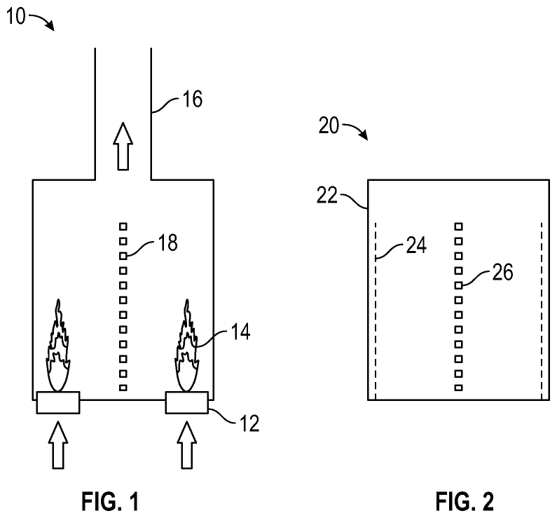

As previously discussed, and as illustrated in FIG. 1, a fired heater 10 includes a burner 12 producing a flame 14. The combustion gases then exit a stack 16. The plurality of process coils 18 transport the fluid to be heated or processed through the radiant box of the heater 10. If a process coil leaks or ruptures, the burners and flame will combust the leaked materials, and their combustion products are transported out of the stack.

A conventional fired heater has a radiant box and an optional convection section for maximum waste heat recovery. Burners are installed in the radiant section. The combustion air enters the heater through the burner wind box and the combustion exhaust is released through a stack either by natural draft or an induced draft fan. The radiant box pressure is regulated by a damper inside the stack or by the induced draft fan.

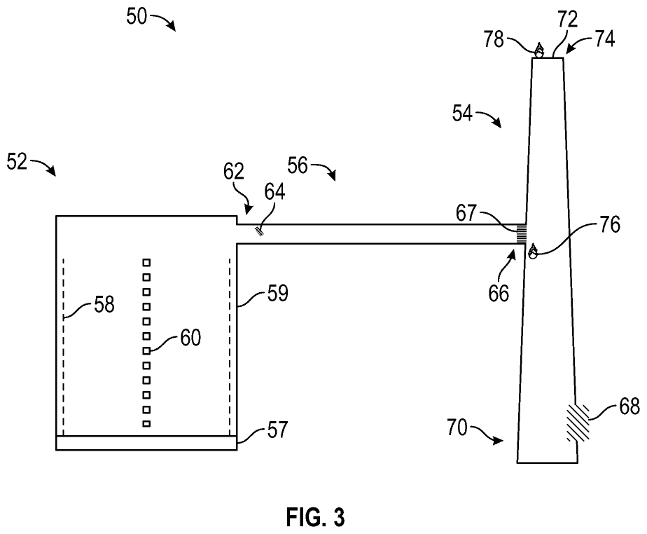

As illustrated in FIG. 2, an electrical heater 20 may include a heater box 22 and electrical heating elements 24 provide radiant energy to heat the plurality of process coils 26 transporting the fluid to be heated or processed through the heater. Absent any means to remedy, a process coil leak or rupture will result in accumulation of leaked materials within the heater box, causing damage to the heater itself, the electrical heating elements, or both. Further, such accumulation may result in a hazardous area unsuitable for entry for maintenance of electrical heating elements, coils, or refractory, among other heater components, as well as a potential for fire or explosion.

With an electrical heater, there will be no fuel firing. Air to the radiant box is not required nor preferred to minimize heat being carried away by the air. Since there is no combustion flue gas, a stack will not be necessary under normal operating conditions. However, when there is any process coil cracks or rupture, the process stream will leak into the electrical heater box and cause a pressure increase. Therefore, pressure relief is necessary when a process coil crack or rupture occurs.

When an electrical heater is designed with an overhead or self-supporting stack, the stack will generate extra draft to the radiant box which causes aerodynamic fluctuation inside the radiant box. In addition, the unburned combustible can only be burned after exiting the stack where oxygen will be available. The combustion will rely on a pilot that may become unstable when the ambient environment changes and may fail to ignite the combustible leaking through the stack.

When an electrical heater is connected to a fired heater, the leaking combustible may be ignited and burned by the hot flue gas from the fired heater. Depending upon the combustible concentration and oxygen content in the flue gas of the fired heater, the combustible may result in high CO, unburned hydrocarbon emissions, or failure to ignite the combustible and cause uncontrolled combustible hydrocarbon pollution.

In contrast to the above, embodiments herein are directed toward electrical heaters and use in effectively processing and heating hydrocarbons and other material as well as dealing with unwanted situations, such as a process coil rupture. Electrical heaters according to embodiments herein include one or more pressure relief doors in a duct and the duct is linked to a stack. When there is a pressure increase in the electrical heater, the pressure relief door will open and direct the high-pressure stream to the stack through the connecting duct. The duct and the stack are connected in a manner that will not cause any open flame or result in any hazardous working environment around the electrical heater. The combustible or high-pressure stream will thus be released at a safe location. The stack will also include a pilot flame to minimize combustible release to the environment. In addition, the system will not accumulate any combustible with continued air inflow inside the heater body or the ducting, thus it will not create an explosive mixture.

Embodiments herein also include unique features for the radiant box draft control. Under normal operating conditions without any coil cracks or ruptures, the pressure relief ducting and stack will not induce any extra draft to the radiant box. When ambient condition fluctuates, it has no or has minimal impact to the radiant box aerodynamics, the ambient air or hot furnace gas will be less likely leaking through any connection joints of the heater casing, coils or heating elements penetration area.

When there is any coil cracks or ruptures, the pressure relief door will open at relatively low radiant box pressure excursion. The combustible or high pressure/temperature stream will be contained in a controlled environment leading to a stack. This will not result in an open flame or a hazardous zone near the open explosion doors.

Once the combustible material flows to the stack, the combustible material, if not already combusted with the oxygen in the hot radiant box and the hot gas duct, will be ignited by a pilot located at the first exit point to the air stream through the stack.

The stack will generate the necessary draft that will induce ambient air through the regulating dampers at the bottom of the stack. The more hydrocarbon that leaks into the stack, the higher combustion temperature, consequently, the higher draft and higher ambient air induction. This will be self-regulating to the ambient air flow to complete the combustible combustion.

Further, when a process coil crack or rupture has occurred, the combustible or hazardous stream may fill the radiant box completely or partially. A purge gas, improperly introduced, may cause thermal shock to the heating surface of the heating elements. The radiant box purge will also be necessary before the restart of the heater or change in the heater operating environment. Embodiments herein may include features to purge the sealed electrical heater box enclosure, during cooling/shutdown, or prior to start-up.

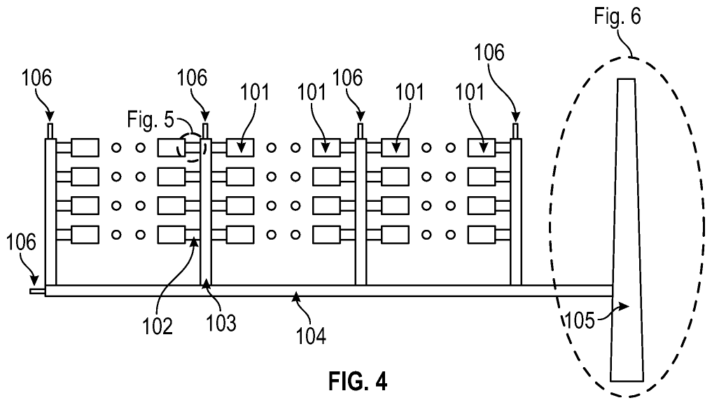

FIG. 3 illustrates an electrical heater system 50 according to some embodiments herein. The system includes an electrical heater 52, a stack 54, and a fluid conduit 56 connecting the electrical heater and the stack. One or more embodiments herein also include a purge gas distribution system 57.

The electrical heater 52 includes an enclosure 59, along the walls, ceiling, and/or floor of which is disposed refractory (not illustrated). Disposed within the enclosure are multiple electrical heating elements 58. Also housed within the enclosure is a plurality of process coil 60, arranged relative to the electrical heating elements so as to be heated by radiant energy from the electrical heating elements, thereby providing energy to a process fluid, such as a hydrocarbon or other reactant or substance, flowing through the process coil.

Fluid conduit 56 provides a flow passage connecting an outlet 62 of the enclosure with an inlet 66 of stack 54. A pressure relief mechanism 64 and a flame holder 67 are provided to control a flow of fluids between enclosure outlet 62 and stack inlet 66. Enclosure outlet 62 may also be referred to as an inlet 62 of fluid conduit 56; similarly, stack inlet 66 may be referred to as outlet 66 of fluid conduit 56.

Stack 54 includes an air draft inlet 68, proximate a lower end 70 of the stack. Stack 54 may be located on a horizontal plane either on the ground or on an elevated structure. Stack 54 also includes a flue gas outlet 72 at a top 74 of the stack. A pilot 76 is provided proximate stack inlet 66 for combusting flammable materials flowing from fluid conduit 56 into the stack with air received from air draft inlet 68. The size of the air draft inlet 68 may be fixed or adjustable by either a manual or automatic mechanism. The air draft inlet 68 may also be configured to prevent combustible or hot exhaust gas from escaping the stack 54. Although not shown in the figure, the air draft inlet 68 may be fluidly connected to a blower which may blow air or other gases into the stack 54. Finally, the stack 54 cross-section may be configured in a circular, rectangular, or any other shape suitable for exhaust flow requirements and mechanical restrictions. Optionally, an additional pilot 78 may be provided proximate the flue gas outlet to combust any materials incompletely combusted within the flue gas stack.

Systems herein, such as that illustrated in FIG. 3, may also include a pilot flame monitoring device (not illustrated). For example, a flame rod or a UV scanner may be used to ensure the pilot is on and in service operating as expected. Further, systems herein may include one or both manual and automated controls (not illustrated) for setting a position of the draft inlet 68. During normal (non-venting) operations, the door may be maintained at a pre-set minimum opening, and may be fully opened when a coil leak or rupture is detected, either controlled by an operator or automatically linked to the leak detection system (sensors, etc. placed near the heater outlet, as described above). Following remedy of the leak or rupture and purge of the radiant box, the draft inlet may then be returned to the normal position.

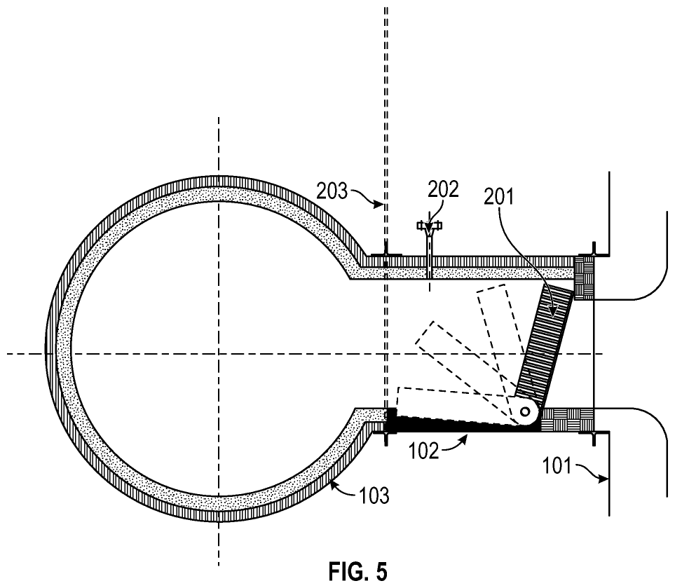

FIG. 4 illustrates an arrangement of a multiple electrical heater system according to embodiments herein. While FIG. 3 illustrates a single heater 52 connected to a stack 54 according to embodiments herein, other embodiments include multiple electrical heaters connected to a single stack.

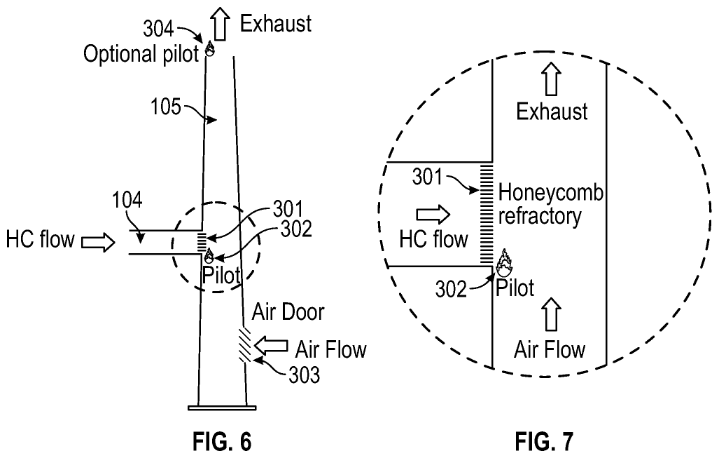

FIG. 4 shows multiple radiant or electrical heater boxes 101 with electrical heating. Each electrical heater box has at least one pressure relief mechanism (FIG. 5, 201). The pressure relief mechanism is located inside a duct 102 connected to a header, which as illustrated includes common branch ducting 103 connected to a main duct 104. The main duct 104 will connect to a stack 105 that provides induced draft to move the combustibles or high pressure/temperature stream to a safe location. The heaters and stack may be similar to those as described with respect to FIG. 3. In such an arrangement, the pressure relief mechanisms and flow rate of the draft may prevent combustible material from one electrical heater box from entering another electrical heater box through ducts 102, 103, and 104. The main duct 104 may be cylindrical, rectangular, or of any other shape suitable for the exhaust flow requirements and mechanical restrictions. One or more purge connections 106 disposed on common branch ducting 103 and/or main duct 104 may be present in order to maintain conditions in the duct environment.

FIG. 5 shows a pressure relief mechanism 201, such as a pressure relief door, useful in embodiments of electrical heater systems herein. Each heater may have one or multiple doors 201, depending upon the pressure relief need and the system operating conditions. Instrument connections 202 can be used for sampling to detect if there is any process stream leakage, such as combustible material or specific components in the process stream. The connection and associated sensors also can be used to detect the system pressure variation or temperature excursion. In some embodiments, the pressure relief mechanism 201 may be in the closed position to enable isolation of the heater box 101 from other heater boxes in FIG. 4. In other embodiments, the pressure relief mechanism 201 may be in the open position once the heater box 101 is under positive pressure exceeding the pressure relief setpoint or once the pressure relief mechanism 201 receives a positive pressure signal. The pressure relief mechanism 201 may be connected to a mechanical member configured such that the door of the pressure relief mechanism 201 remains intact after switching to the open position, thereby preventing the door or any mechanical parts to flow downstream into the ducting upon entering the open position. Once the pressure relief mechanism 201 is in the open position, the door may be repositioned from the opened to the closed position either manually or automatically. The door of the pressure relief mechanism 201 may include a position indicator (not shown) which may indicate the position of the door. The material of door of the pressure relief mechanism 201 may include insulating material or any other material suitable for the temperature of service.

Downstream of the pressure relief door, there may be an isolation valve, such as a guillotine gate valve 203, a knife gate valve, a slide gate valve, or other mechanisms known in the art for use in isolating or blocking gaseous flow in a conduit. When the radiant box needs to be isolated from the reminder of the system for maintenance or the electrical heater out of service, a positive isolation guillotine valve may prevent any hazardous gas from migrating into the isolated electrical heater. When necessary, a guillotine valve may alternatively or additionally be installed upstream of the pressure relief door. Such isolation valves may be manually or remotely operated, and in some embodiments operation of the valve may be performed automatically following an air purge of the radiant box.

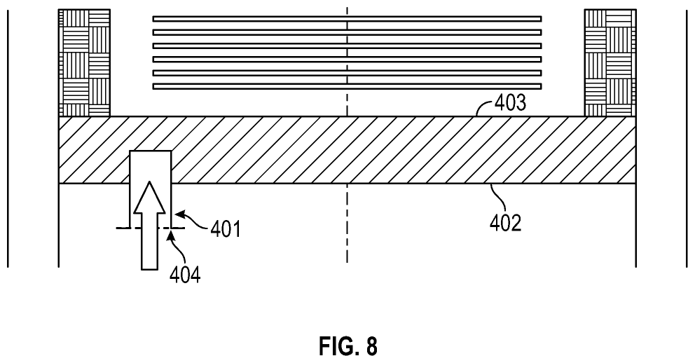

FIG. 6 illustrates a design configuration for a stack for electrical heater systems according to embodiments herein. FIG. 7 shows an exploded view of the stack inlet area.

FIG. 6 shows details of the stack design. Prior to the combustible material moving into the stack, there will be a flame holder 301. The flame holder 301 will create a pressure drop when there is any flow through the flame holder, mainly to prevent combustion air from moving into the main duct 104 from the stack 105. When combustible material moves into the stack, the pilot 302 next to the flame holder 301 will ignite the combustible material with oxygen from the stack bottom, or air draft inlet, and flow to the exit of the stack 105.

The amount of ambient air (oxygen) will be determined by the draft generated by the stack. When there is no coil crack or rupture, there will be no hot gas flow from the radiant box into the ducting and the stack. The draft by the stack mainly depends upon the air movement surrounding the stack. Once there is a coil crack or rupture, the combustible material or high pressure/temperature stream will flow into the stack due to higher pressure of the radiant box than the pressure inside the stack. The hot gas flow will result in draft inside the stack. If the combustible material is ignited, the combustion will further increase the draft due to further elevated temperature. Higher draft flow will lead to more ambient air flow into the stack through the bottom door 303.

The ambient air containing an amount of oxygen will flow upward and mix with the combustible material passing through the flame holder 301. To ensure all combustible material is combusted prior to its release to the atmosphere, an optional pilot or flame jet 304 may be installed near the exit of the stack or turned on as needed.

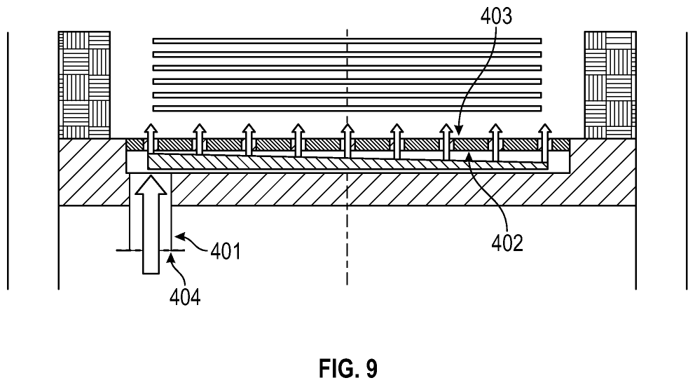

FIGS. 8 and 9 illustrate purge systems useful with embodiments of electrical heater systems according to embodiments herein. FIG. 8 shows one possible radiant box purge arrangement. The electrical heater typically has a narrow enclosure box for maximum heat transfer and lower heating element temperature to minimize the capital cost. A purge stream such as air, nitrogen, steam, or other gas stream will flow into the radiant box. The relative cold purge gas could cause thermal shock to the heating surface or the heating elements. To minimize the thermal shock, the purge stream release nozzles will be distributed widely through the un-occupied heater floor or end wall.

The purge system design will have one or more nozzles 401 outside of the heater casing. Once open, the purge stream will flow inside of the radiant box through a channel 402 with openings 403. The opening may be in different sizes or different numbers to ensure proper flow distribution. The purge stream will be warmed up by the heat contained in the refractory. Further, the purge stream will be spread out at a lower velocity compared with a single or only a few nozzles connections. In this manner, thermal shock and disruption of the atmosphere (turbulence) within the heater may be avoided. Under normal operating conditions, the nozzle will be in closed position with blind flanges or valves 404. When the purge is needed, the nozzle can be opened.

FIG. 9 illustrates another embodiment of a purge system useful with embodiments of electrical heater systems according to embodiments herein. Similar to FIG. 8, a nozzle or plurality of nozzles 401 provide a flow of purge gas to a distribution system. In this embodiment, channel 402 is provided through the refractory, and an arrangement of distributor nozzles 403 is provided to distribute the purge gas into the enclosure. To control a flow of purge gas into the enclosure, distributor nozzles 403 may be of varying sizes distributed along the length (width, or diameter, as the case may be) of the distribution area to provide an even amount of flow per nozzle based on pressure drop through the distributor nozzle openings. Although only one nozzle 401 is shown in the figure, each heater box may have one or more nozzles 401.

As briefly described with respect to the Figures in the above description, electrical heater systems according to embodiments herein include an electrical heater, a stack, and a fluid conduit. Electrical heater systems according to some embodiments herein include two or more electrical heaters fluidly connected to a stack by fluid conduits feeding a common stack header.

The electrical heater (or heaters) includes an enclosure containing refractory, electrical heating elements, and a process coil. The enclosure may be a sealed enclosure, thus limiting influx and outflux of gases, such as ambient air. While some amount of oxygen is useful to be contained within the enclosure for normal operations, it is not desirable for the enclosure to “breathe,” as this may introduce hazardous compositions to the operating area surrounding the enclosure during a process coil leak or rupture event. Rather, a sealed enclosure is desirable such that any components that may be introduced into the enclosure by a process coil leak or rupture, can be withdrawn through the fluid conduit and delivered to the stack for proper combustion of combustible components, such as hydrocarbons, and expulsion of high temperature/high pressure fluids, such as steam being superheated within the heater, to the atmosphere at a safe location.

Refractory may be disposed along the walls, ceiling, and/or floor of the interior of the enclosure. Electrical heating elements may also be disposed along the walls, ceiling, and/or floor of the enclosure, spaced apart from the refractory. The electrical heating elements may be suspended within the enclosure, such as hung from the ceiling, connected to the walls, or connected to the floor of the enclosure. Alternatively, the electrical heating elements may be suspended within the enclosure, such as hung from the refractory along the ceiling, connected to the refractory along the walls, or connected to the refractory along the floor of the enclosure. Appropriate electrical connections may also pass through the enclosure and refractory to provide and distribute power to the electrical heating elements.

One or more process coils may be disposed within the enclosure. Process coils may include, for example, coils that may be used for heating hydrocarbons, heating water, boiling water, superheating heating steam, cracking hydrocarbons, or providing energy to many other various fluids as is known in the art. Various arrangements of the coils and their disposal within the enclosure to capture and efficiently transfer the radiant energy from the electrical heating elements and refractory to the process fluid are also known.

In addition to the other components described above, the sealed enclosure also includes an outlet for venting the enclosure, as well as an inlet for controllably introducing air or a purge gas into the enclosure. The enclosure outlet is connected to a fluid conduit for directing outflow from the enclosure to the stack, which may be located a distance away from the enclosure. That distance may be based on the materials being processed within the process coils and their associated hazard rating, maximum flow through a ruptured coil, and the maximum thermal energy that may result from combustion within the stack, among other factors.

To control a flow of fluid from the enclosure to the stack, and limit or eliminate the possibility of backflow from the stack into the fluid conduit, the electrical heater systems according to embodiments herein include a pressure relief mechanism and a flame holder. The pressure relief mechanism may be disposed at the outlet of the enclosure or slightly downstream of the enclosure outlet and may be configured to maintain a pressure within the electrical heater enclosure of a few inches of water, such as from greater than zero to about five inches of water (0 to 1.25 kPa) (gauge pressure, slightly above atmospheric pressure). Pressure relief mechanisms useful in embodiments herein may include a pressure door, which may be gravity or spring loaded to maintain the desired back pressure, a back pressure flap, or other types of back pressure valves or regulators as known in the art and suitable for use with the ducting or piping of the fluid conduit. In addition to the door mechanism, pressure doors useful in embodiments herein may include any mechanical member including an axis through the door such that the door will not detach while in the open position, and may be manually operated or actuator operated for opening and closing of the door, or both, and may include flexible straps between the door or a fixed structure in the duct. The door mechanism may be composed of any material suitable for the temperature of service including but not limited to insulating material. Additionally, the door of the pressure relief mechanism may typically operate in the closed position and may only be in the opened position when the heater box reaches a positive pressure that exceeds the setpoint pressure of the pressure relief mechanism or when the pressure relief mechanism receives the required positive pressure signal. The door of the pressure relief mechanism may enter the closed position either due to gravity or external force. Finally, a position indicator may be included in the pressure relief mechanism to indicate the status of the door position, i.e. whether the door is in the opened or closed position.

The flame holder may be disposed at the outlet of the fluid conduit (inlet of the stack). Likewise, a pilot may be disposed within the stack proximate the stack inlet, near the flame holder, thereby igniting any combustible materials received from the fluid conduit within the stack. The pilot may be an electric ignitor, an open flame, or other ignition devices known in the art.

The flame holder allows flow of vapors from the fluid conduit into the stack, while restricting a flow of vapors from the stack into the fluid conduit. In other words, the pressure within the fluid conduit and the pressure drop across the flame holder should be sufficient compared to the pressure within the stack proximate the flame holder to prevent flow of oxygen and other vapors into the fluid conduit. It is desirable to prevent travel of the flame front into the fluid conduit toward the heater enclosure, maintaining the flame at the location of the stack, and thus the configuration and design of the flame holder should be sufficient to keep the flame only within the stack (no open flame until the stack). The flame holder may be, for example, a porous flame holder, a honeycomb refractory, a metallic flow spoiler, or a device to create a stable flow recirculation zone, among other possible configurations akin to a porous refractory wall or a refractory wall with openings.

The inlet from the fluid conduit into the stack may be intermediate a top and bottom of the stack. An air draft inlet, providing combustion air to the stack, may be located at a lower end of the stack, permitting influx of cool air. The air draft inlet size may either be fixed or adjustable by manual or automatic methods. In embodiments where the air draft inlet size is adjustable, the device enabling adjustment of the air draft inlet size may additionally prevent the egress of any combustible or hot exhaust gas from escaping the stack. Additionally, the air draft inlet may be fluidly connected to a blower configured to blow air or other gases into the stack. The stack may also include a flue gas outlet at a top of the stack. As noted above, the draft within the stack, from air draft inlet to flame holder to flue gas outlet, should have essentially no impact on draft within the heater box or the fluid conduit. A neutral draft within the heater enclosure and the fluid conduit is desired during normal operation. If anything, during normal operation with no ruptures or leaks, the small heating of the air within the stack provided by the pilot may cause a slight pull on the fluid conduit due to the Bernoulli effect. However, such draw should be minimal, and the flame holder may be designed to prevent flow within the stack impacting the draft within the fluid conduit and the heater box. Prior to the combustible material flowing into the stack, the flame holder will create a pressure drop when there is any flow through it, mainly to prevent combustion air move into the fluid conduit from the stack. When combustible material flows into the stack, the pilot next to the flame holder will ignite the combustible material with oxygen flowing up from the stack bottom to the exit of the stack.

The amount of ambient air (oxygen) will be determined by the draft generated by the stack. When there is no coil crack or rupture, there will be no hot gas flow from the radiant box into the ducting and the stack. The draft by the stack mainly depends upon the air movement surrounding the stack. Once there is a coil crack or rupture, the combustible material or high pressure/temperature stream will flow into the stack due to higher pressure of the heater box than the pressure inside the stack. The hot gas will result in a draft inside the stack. If the combustible material gets ignited, the combustion will further increase the draft due to further elevated temperature. Higher draft will lead to more ambient air flow into the stack through the bottom door. The ambient air containing an amount of oxygen will flow upward and mix with the combustible passing through the flame holder. To ensure all combustibles are combusted prior to its release to the atmosphere, an optional pilot or flame jet may be installed near the exit of the stack or turned on as needed (at the flue gas outlet or proximate a top of the stack).

While described above with respect to a bottom, top, and intermediate portion of the stack, it should be recognized that the stack inlet should be located at an appropriate height for air flow to develop appropriately within the stack so as to avoid extinguishing of the flame, back flow of combustibles, or other undesired effects. Thus, locating the stack inlet intermediate the air draft inlet and the flue gas outlet provides for proper flow and combustion of the combustibles within the stack. With the stack inlet and combustion occurring at within the stack, such as slightly above or below a mid-height of the stack, embodiments herein also provide for maintaining combustion at a higher temperature while also providing additional residence time for combustion at the higher temperature prior to expulsion of the flue gas to the atmosphere. Such may provide for more complete combustion as well as providing for a decreased radiant zone around the stack, which may have advantages in design and location of a plant layout. Accordingly, the air draft inlet is located proximate a lower portion or bottom of the stack, the flue gas outlet is at a top of the stack, and the stack inlet/flame holder/pilot are disposed intermediate the air draft inlet and the flue gas outlet. Finally, the stack, may be any shape that is suitable for the exhaust flow and mechanical requirements and the stack may be located on a horizontal plane on the ground or on an elevated structure.

The heater enclosure, as noted above, includes an inlet for controllably introducing a purge gas. The purge gas may be, for example, air, nitrogen, carbon dioxide, or other suitable gases that may be used to establish an environment within the enclosure at startup, sweep the enclosure during a leakage or rupture event, and/or to control or establish an environment within the enclosure during shutdown or maintenance. The purge gas may be introduced when needed via natural draft or forced draft from an appropriate source.

While introduction and control of the environment within the enclosure may be provided by introducing the purge gas at any portion of the enclosure, some embodiments herein take advantage of the natural draft within the enclosure, sweeping from the floor or proximate the floor of the enclosure to the enclosure outlet, which may be located within a ceiling or proximate the ceiling of the enclosure, such as near a top of a wall of the enclosure. In this manner, the heat from the heating elements may cause a natural draft within the enclosure, sweeping from the lower inlet to the higher outlet. The enclosure purge inlet in some embodiments is located within a floor of the enclosure. The enclosure purge inlet in other embodiments is located along a wall proximate the floor, such as along the wall just above the floor, intermediate the floor and the lowermost electric heating elements.

The enclosure purge inlet according to embodiments herein is configured to provide a distributed flow of purge gas into the enclosure. By distributing the flow along or across the floor of the enclosure, a relatively low velocity of the purge gas may be provided, limiting disturbance (turbulence, flow eddies) within the enclosure that may impact sweep efficiency.

Purge gas flow distribution may be provided, for example, by flow conduits, tunnels, or channels within or under the refractory wall or floor. A porous refractory may provide for distribution of the purge gas through the wall or floor in some embodiments. In other embodiments, a network of tubing, channels, or tunnels under or within the refractory may be provided to receive and distribute the purge gas into the enclosure.

Arrangement of the purge gas distribution proximate (within or under) the refractory is advantageous when introducing purge gas when the electric heating elements are hot. As the purge gas traverses the distribution network, the purge gas may be heated by the refractory before exiting the distributor into the enclosure. In this manner, thermal shock of the heating elements may be avoided. Further, the distribution of the flow across a larger area provides for a relatively low velocity, further limiting the shock that may result due to any temperature difference between the purge gas introduced and the nearest electric heating elements. During shutdown procedures, the natural draft, distributed flow, and heat exchange with the refractory during distribution may also provide for an overall slow cooling effect on the heater, which may limit or prevent negative impact on the electric heating elements. While not anticipated as being needed, embodiments herein further contemplate pre-heating of the purge gas prior to introducing the purge gas into the distributor.

As noted above, the purge gas may be distributed through the floor and/or lower portions of the walls of the enclosure. The refractory bricks may be porous refractory, under which tunnels, channels, or tubing may be provided to distribute the purge gas under or into the porous refractory. In other embodiments, a perforated tubing may be provided under the refractory. In yet other embodiments, refractory bricks or castables may be provided with openings to distribute the flow of purge gas into the enclosure. For embodiments having perforated tubing or spaced openings, the openings or perforations proximate a primary flow inlet may be smaller, and openings or perforations distal the primary flow inlet may be larger, thereby equalizing distribution of the purge gas along the network, introducing a fairly even rate of flow across the entire distribution area.

In some embodiments, the purge gas distribution system may be fluidly connected to a supply of air and a supply of nitrogen or carbon dioxide. It may be preferred to purge with nitrogen, for example, limiting any possible reaction or combustion until the flow reaches the stack. However, for maintenance purposes and safe entry into the enclosure, it may be necessary or preferred to have a breathable environment within the enclosure. Further, some amount of oxygen may be required for typical electrical heater operations, such as an environment having at least 1-2 vol % molecular oxygen, and thus having an ability to introduce air or oxygen into the enclosure, or to controllably introduce air or oxygen into the enclosure, can provide for setting or re-setting the atmosphere for each of startup, normal operations, purge, shutdown, or maintenance. As the enclosure is a sealed enclosure, with minimal or no draft during normal operations, the purge gas feed system allows for easily controlling or adjusting the environment within the enclosure.

Sensors may be provided within the enclosure, within the fluid conduit, and/or within the stack to measure an environment proximate the sensor. Sensors, for example, may be provided to measure one or more of temperature, pressure, oxygen content, carbon dioxide content, combustibles content, nitrogen content, flow, or other various environmental conditions. Sensors may be located, for example, immediately upstream of a pressure relief mechanism, proximate the enclosure outlet. As another example, sensors may be located immediately downstream of a pressure relief mechanism. In other embodiments, sensors may be located both upstream and downstream of the pressure relief mechanism.

Small, continuous leaks, for example, may consume some oxygen present in the heater enclosure. As such, a sensor may detect a change in oxygen content, a change in carbon dioxide content, or a temperature or pressure rise, indicating a potential leak that may be investigated. Even with a minor leak, the small increase in pressure may result in a small discharge through a pressure door, and thus a sensor located within or even downstream of the pressure relief mechanism may be used to monitor the enclosure environment for leaks. Tube rupture will be more apparent.

The sensor readings may be provided to a control system. The control system may provide for monitoring and control of the heater operations, such as monitoring inlet and outlet temperatures, pressures, electric heating element operations, and other aspects of the heater. Further, the control system may be configured to infer a condition or a change in a condition of an environment within the enclosure. For example, a small change in carbon dioxide content of a sensor within the enclosure or downstream of the pressure relief mechanism may trigger a control system to send a visual or audible alarm indicating a possible process coil leak.

As described above for a single heater, the multiple heater arrangements, such as those illustrated in FIG. 4, may include, for each individual heater of the multiple heaters, pressure relief mechanisms, sensors, and purge gas distribution systems. Further, while a pressure door proximate an enclosure outlet may prevent backflow of discharge from one heater to another, multiple pressure relief mechanisms (multiple pressure doors) may be provided along the collection header along the flow path from a bank of heaters to the stack to effectively limit the potential for backflow into one or more heater banks. The collection header along the flow path from a bank of, heaters to the stack may be ducting that is of any shape suitable for exhaust flow requirements and mechanical restrictions, including but not limited to cylindrical or rectangular. There may additionally be purge connections at one or more points along the ducting to enable maintenance of the duct environment.

As described above for the electrical heater, the radiant box purge and pressure relief will be useful for safe heater operation. The purge and pressure relief need to be reliable and safe. On the other hand, the system should not interfere with the heater normal operation. Embodiments herein provide purge and pressure relief only when required and will not interfere with the heater normal operation. When the purge and pressure relief system is engaged, it will not cause any thermal shock to the heating surface or the heating elements. The pressure relief will not create an open flame to impose any hazardous environment that could endanger the nearby operators or equipment. The combustible or hazardous stream release will be ducted to a safe location. In particular, the pressure relief will be self-regulating and requires minimal operator intervention which add additional safety protection to the operator and surrounding equipment or structures.

As described above, embodiments herein are directed toward an electrical heater system. In some embodiments, the electrical heater system includes an electrical heater and a stack. The electrical heater may include an enclosure containing a refractory, electrical heating elements, and a process coil. The stack has an air draft inlet proximate a lower portion of the stack and a flue gas outlet at a top of the stack. A fluid conduit fluidly connects the enclosure to the stack at a location intermediate the air draft inlet and the flue gas outlet. A pressure relief mechanism is disposed at an outlet of the enclosure or within the fluid conduit, configured for exhausting fluid from the enclosure into the fluid conduit and thence to the stack. A flame holder within the stack is configured for permitting fluid flow from the fluid conduit into the stack while restricting flow of air or flame into the fluid conduit. Further, a pilot is disposed within the stack proximate the flame holder to ignite combustibles flowing from the enclosure into the stack.

In some embodiments, the flame holder comprises a porous flame holder, a honeycomb refractory, a metallic flow spoiler, or a device to create a stable flow recirculation zone. In some embodiments, the system further includes a pilot located at the flue gas outlet or proximate a top of the stack.

The pressure relief mechanism of some embodiments herein comprises a pressure door, a back pressure valve, a back pressure regulator, or a back pressure flap.

Electrical heating systems according to embodiments herein may include a purge gas distribution system disposed in a floor of the enclosure. In other embodiments, electrical heating systems herein may include a purge gas distribution system disposed in a wall along a floor of the enclosure. Each heater box in the electrical heating system may include one or more purge gas connections from the purge gas distribution system.

Systems according to various embodiments herein may further include a sensor disposed within the enclosure, wherein the sensor is configured to measure one or more properties of an environment within the enclosure. In other embodiments, systems herein may additionally or alternatively include a sensor disposed within the fluid conduit proximate the pressure relief mechanism, wherein the sensor is configured to measure one or more properties of an environment within the fluid conduit.

Various embodiments of systems herein further include an isolation valve intermediate the enclosure and the pressure relief mechanism, an isolation valve downstream of the pressure relief mechanism, or both.

Embodiments of systems herein may additionally include a control system configured to infer a condition of an environment within the enclosure based upon a reading of the sensor disposed within the fluid conduit. Some embodiments of the control systems herein, such as a distributed control system or other computerized control systems commonly used at commercial facilities, may include programming or stored instructions to perform various operations related to starting up, operating, and shutting down the heating systems described herein. For example, control systems herein may be configured for one or more of: controlling a supply of electrical energy to the electrical heating elements; controlling a flow of fluid to the one or more process coils; controlling a flow of purge gas into the enclosure; controlling a flow of air or oxygen into the enclosure; controlling a cooling rate of the electrical heating coils during a shutdown of the heating system; inferring an environment within the enclosure or within the fluid conduits proximate an outlet of the enclosure; detecting or inferring a leak or rupture of a process coil; controlling a position of isolation valves disposed along the fluid conduit; controlling a position of the air draft inlet; determining an operating condition of the pilots; as well as providing a graphical display of operating conditions for the electrical heater system, stack, and associated equipment, and providing audible or visual alarms for a measured, detected, or inferred condition requiring action by an operator.

Control systems according to embodiments herein may be configured for operating an electrical heating system as described herein. For example, the control system may be configured to control supplying of electrical energy to the electrical heating elements to provide radiant energy to the plurality of process coils. The control system may also be configured to control a flow of fluid passing through the plurality of process coils being heated via the radiant energy. Further, the control system may be configured to detect or infer a leak or rupture of a process coil that is introducing a leaked process fluid into the enclosure. In a leakage or rupture event, the leaked process fluid will be directed through an outlet of the enclosure into the fluid conduit and thence to the stack, where the pilot will ignite combustible components of the leaked process fluid.

The control system may also be configured for stopping a flow of fluid to a leaking or ruptured coil. Upon stopping of the flow of leaking fluid into the enclosure, the control system may initiate a flow of purge gas into the enclosure. The purge gas will be heated via a distribution system in a refractory floor, thus introducing a heated purge gas into the enclosure via multiple outlets of the distribution system. The purge gas and any entrained process fluid may then be withdrawn into the fluid conduit and thence to the stack. To avoid thermal shock, the heating of the purge gas via heat provided from the refractory may provide for limited thermal shock. Nonetheless, the control system may be configured to control a flow rate of the purge gas into the enclosure and to control a cooling rate of the electrical heating elements. Following purge of the enclosure, and determining via sensors that the process fluid has been flushed, the control system may adjust an environment within the enclosure, such as by controlling a flow of air or oxygen into the enclosure, and then may fluidly isolate the enclosure from the fluid conduit and the stack, thereby providing for safe entry into the enclosure for repair or replacement of the leaking or ruptured coil.

Control systems according to embodiments herein may also be configured for shutting down a heater to which electrical energy is being provided to the electrical heating elements and flow of a fluid to be heated is being provided to the process coils. The shutting down of the electrical heating system may include: terminating the electrical energy being supplied to the electrical heating elements; heating a purge gas within a distribution system disposed in refractory of the enclosure, such as a refractory floor of the enclosure; and introducing the heated purge gas into the enclosure. The control system, as described above for leak or rupture events, may be configured to control a flow rate of purge gas into the enclosure, control a cooling rate of the electrical heating elements, as well as stopping a flow of purge gas into the enclosure, adjusting an environment within the enclosure, and fluidly isolating the enclosure.

In another aspect, embodiments herein are directed toward an electrical heater system including an electrical heater comprising an enclosure containing a refractory, electrical heating elements, and a process coil. The system also includes a stack having an air draft inlet proximate a lower portion of the stack and a flue gas outlet at a top of the stack. A fluid conduit fluidly connects the enclosure to the stack, and a pressure relief mechanism is provided for exhausting fluid from the enclosure into the fluid conduit. The system further includes a purge gas distribution system disposed in a floor of the enclosure or in a wall along the floor of the enclosure. In various embodiments, the purge gas distribution system comprises one or more of tubing, tunnels, or channels within or under the refractory. In some embodiments, the purge gas distribution system is arranged under a perforated or porous refractory. The purge gas distribution system of other embodiments herein comprises a primary inlet and a plurality of outlets, wherein the plurality of outlets increase in size between the primary outlet and a distal outlet.

In yet another aspect, various embodiments herein are directed toward an electrical heater system including two or more electrical heaters, each comprising an enclosure containing refractory, electrical heating elements, and a process coil. The electrical heater system also includes a stack having an air draft inlet proximate a lower portion of the stack and a flue gas outlet at a top of the stack. A fluid collection system fluidly connects each of the enclosures to the stack, the fluid collection system including inlet fluid conduits, a header, and a header outlet. The fluid collection system may also include a pressure relief mechanism disposed proximate a fluid outlet of each enclosure, each pressure relief mechanism configured for exhausting fluid from a respective enclosure into a respective inlet fluid conduit. The header fluidly connects two or more inlet fluid conduits, configured for receiving fluids from each of the two or more inlet fluid conduits and for directing a flow of received fluids to the header outlet and thence into the stack for combustion of combustibles within the received fluids.

As described for heater systems in other embodiments, the multiple heater systems herein may be configured such that each of the two or more electrical heaters comprise a purge gas distribution system. The purge gas distribution system may be disposed in a floor of the enclosure or in wall along a floor of the enclosure.

Further, the multiple heater systems may include a sensor is disposed in each of the two or more electrical heaters, in each fluid conduit proximate a respective pressure relief mechanism, or both. The sensors may be configured to measure one or more properties of an environment proximate the respective sensor.

Further, the multiple heater systems herein may include a control system configured to infer a condition of an environment within an enclosure based upon a reading of the respective sensor, and wherein the control system is further configured to automatically purge and isolate an enclosure upon detection of a coil leak or coil rupture. The control system may also include other aspects as described above for operating the multiple heater system, detecting a leak or rupture and taking action upon detecting of the leak or rupture, as well as purging, fluidly isolating, and adjusting an environment within the enclosure. For example, the system may include an isolation valve disposed upstream, downstream, or both, relative to each pressure relief mechanism associated with each enclosure, and the control system may be configured to control a position of the isolation valve during the shutdown of the electrical heater.

In some embodiments, the header is fluidly connected to a first plurality of electrical heaters via a first fluid conduit, and the header is fluid connected to a second plurality of electrical heaters via a second fluid conduit. The system of such embodiments may further include a pressure relief mechanism disposed in each of the first and second fluid conduits for restricting a flow of fluids in an upstream direction from the header into the first and second fluid conduits.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. An electrical heater system, comprising:
an electrical heater comprising an enclosure containing a refractory, electrical heating elements, and a process coil;
a stack having an air draft inlet proximate a lower portion of the stack and a flue gas outlet at a top of the stack;
a fluid conduit fluidly connecting the enclosure to the stack intermediate the air draft inlet and the flue gas outlet;
a pressure relief mechanism configured for exhausting fluid from the enclosure into the fluid conduit; and
a flame holder configured for permitting fluid flow from the fluid conduit into the stack while restricting flow of air or flame into the fluid conduit; and
a pilot disposed within the stack proximate the flame holder.

2. The system of claim 1, wherein the flame holder comprises a porous flame holder, a honeycomb refractory, a metallic flow spoiler, or a device to create a stable flow recirculation zone.

3. The system of claim 1, comprising a pilot located at the flue gas outlet or proximate a top of the stack.

4. The system of claim 1, wherein the pressure relief mechanism comprises a pressure door, a back pressure valve, a back pressure regulator, or a back pressure flap.

5. The system of claim 1, comprising a purge gas distribution system disposed in a floor of the enclosure.

6. The system of claim 1, comprising a purge gas distribution system disposed in a wall along a floor of the enclosure.

7. The system of claim 1, further comprising a sensor disposed within the enclosure, the sensor configured to measure one or more properties of an environment within the enclosure.

8. The system of claim 1, further comprising a sensor disposed within the fluid conduit proximate the pressure relief mechanism, the sensor configured to measure one or more properties of an environment within the fluid conduit.

9. The system of claim 8, further comprising a control system configured to infer a condition of an environment within the enclosure based upon a reading of the sensor disposed within the fluid conduit.

10. The system of claim 1, further comprising an isolation valve intermediate the enclosure and the pressure relief mechanism, an isolation valve downstream of the pressure relief mechanism, or both.

11. An electrical heater system, comprising:
an electrical heater comprising an enclosure containing a refractory, electrical heating elements, and a process coil;
a stack having an air draft inlet proximate a lower portion of the stack and a flue gas outlet at a top of the stack;
a fluid conduit fluidly connecting the enclosure to the stack;
a pressure relief mechanism configured for exhausting fluid from the enclosure into the fluid conduit; and
a purge gas distribution system disposed in a floor of the enclosure or in a wall along the floor of the enclosure.

12. The system of claim 11, wherein the purge gas distribution system comprises one or more of tubing, tunnels, or channels within or under the refractory.

13. The system of claim 12, wherein the purge gas distribution system is arranged under a perforated or porous refractory.

14. The system of claim 12, wherein the purge gas distribution system comprises a primary inlet and a plurality of outlets, wherein the plurality of outlets increase in size between the primary outlet and a distal outlet.

15. The system of claim 11, wherein the fluid conduit is fluidly connected to the stack intermediate the air draft inlet and the flue gas outlet via a flame holder.

16. The system of claim 15, wherein the stack comprises a pilot disposed proximate the flame holder.

17. The system of claim 16, wherein the stack comprises a second pilot disposed at the flue gas outlet.

18. The system of claim 16, wherein the stack comprises a second pilot disposed proximate a top of the stack.

19. The system of claim 11, wherein the fluid conduit fluidly connects the enclosure to the stack intermediate the air draft inlet and the flue gas outlet.

20. The system of claim 19, further comprising a flame holder configured for permitting fluid flow from the fluid conduit into the stack while restricting flow of air or flame into the fluid conduit.

21. An electrical heater system, comprising:
two or more electrical heaters, each comprising an enclosure containing refractory, electrical heating elements, and a process coil;
a stack having an air draft inlet proximate a lower portion of the stack and a flue gas outlet at a top of the stack;
a fluid collection system fluidly connecting each of the enclosures to the stack and including inlet fluid conduits, a header, and a header outlet, the fluid collection system comprising:
a pressure relief mechanism disposed proximate a fluid outlet of each enclosure, each pressure relief mechanism configured for exhausting fluid from a respective enclosure into a respective inlet fluid conduit;
a header fluidly connecting two or more inlet fluid conduits, configured for receiving fluids from each of the two or more inlet fluid conduits and directing a flow of received fluids to the header outlet;
a flame holder configured for permitting fluid to flow from the header outlet into the stack while restricting flow of air or flame into the fluid conduit; and
a pilot disposed within the stack proximate the flame holder.

22. The system of claim 21, wherein the header outlet into the stack and the flame holder are positioned intermediate the air draft inlet and the flue gas outlet.

23. The system of claim 22, further comprising a pilot located at the flue gas outlet or proximate a top of the stack.

24. The system of claim 21, wherein each of the two or more electrical heaters comprise a purge gas distribution system.

25. The system of claim 21, wherein the purge gas distribution system is disposed in a floor of the enclosure or in wall along a floor of the enclosure.

26. The system of claim 21, wherein a sensor is disposed in each of the two or more electrical heaters, in each fluid conduit proximate a respective pressure relief mechanism, or both, the sensors configured to measure one or more properties of an environment proximate the respective sensor.

27. The system of claim 26, further comprising a control system configured to infer a condition of an environment within an enclosure based upon a reading of the respective sensor, and wherein the control system is further configured to automatically purge and isolate an enclosure upon detection of a coil leak or coil rupture.

28. The system of claim 27, further comprising an isolation valve disposed upstream, downstream, or both, relative to each pressure relief mechanism.

29. The system of claim 21, wherein the flame holder comprises a porous flame holder, a honeycomb refractory, a metallic flow spoiler, or a device to create a stable flow recirculation zone.

30. The system of claim 21, wherein the header is fluidly connected to a first plurality of electrical heaters via a first fluid conduit, and is fluid connected to a second plurality of electrical heaters via a second fluid conduit, the system further comprising a pressure relief mechanism disposed in each of the first and second fluid conduits for restricting a flow of fluids in an upstream direction from the header into the first and second fluid conduits.

31. A method of operating an electrical heating system including an enclosure containing refractory, electrical heating elements, and a plurality process coils, the method comprising:
supplying electrical energy to the electrical heating elements to provide radiant energy to the plurality of process coils;
passing a process fluid through the plurality of process coils and heating the process fluid via the radiant energy;
detecting a leak or rupture of a first of the plurality of process coil introducing a leaked process fluid into the enclosure;
directing the leaked process fluid through an outlet of the enclosure into a fluid conduit and from the fluid conduit to a refractory inlet of a stack, the refractory inlet being disposed intermediate a draft inlet and a flue gas outlet of the stack; and
igniting the leaked process fluid within the stack via a pilot disposed proximate the refractory inlet.

32. The method of claim 31, further comprising:
initiating a flow of purge gas;
heating the purge gas via a distribution system disposed in a refractory floor of the enclosure to produce a heated purge gas; and
introducing the heated purge gas into the enclosure via multiple outlets of the distribution system; and
withdrawing the purge gas through the outlet of the enclosure into the fluid conduit and thence to the stack.

33. The method of claim 32, further comprising:
stopping a flow of fluid to the first of the plurality of process coil;
isolating the enclosure from the fluid conduit and the stack; and
repairing the first of the plurality of process coil.

34. The method of claim 33, further comprising adjusting an environment within the enclosure via the distribution system, and sensing via a sensor disposed within the enclosure that the environment is suitable for entry to perform the repairing.

35. The method of claim 31, further comprising fully opening an air draft inlet of the stack upon detection of the leak or rupture.

36. A method of shutting down an electrical heating system including an enclosure containing a refractory disposed on walls, ceiling, and floor of the enclosure, electrical heating elements, and one or more process coils, the method comprising:
supplying electrical energy to the electrical heating elements to provide radiant energy to the one or more process coils and the refractory, including the refractory floor;
terminating the electrical energy being supplied to the electrical heating elements;
heating a purge gas within a distribution system disposed in the refractory floor; and
introducing heated purge gas into the enclosure.

37. The method of claim 36, further comprising controlling a flow rate of the purge gas into the enclosure and controlling a cooling rate of the electrical heating elements.

38. The method of claim 37, further comprising stopping a flow of the purge gas into the enclosure and fluidly isolating the enclosure.
